(19) United States
(12) Patent Application Publication
(10) Pub. No.: US 2008/0083700 A1
(43) Pub. Date: Apr. 10, 2008

(54) Method and Apparatus for Maximizing Cooling for Wafer Processing

(75) Inventors: David Laurier Bernard, Lexington, KY (US); Paul William Dryer, Lexington, KY (US); John William Krawczyk, Richmond, KY (US); Andrew Lee McNees, Lexington, KY (US); Girish Shivaji Patil, Lexington, KY (US); Richard Lee Warner, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: LEXMARK INTERNATIONAL, INC., Lexington, KY (US)

(21) Appl. No.: 11/562,081

(22) Filed: Nov. 21, 2006

Related U.S. Application Data
(60) Provisional application No. 60/828,906, filed on Oct. 10, 2006.

(51) Int. Cl. C03C 25/68; C23F 1/00

(52) U.S. Cl. 216/55; 216/58; 216/71; 156/345.23

(57) ABSTRACT

Methods for processing wafers, wafer processing apparatus, micro-fluid ejection head substrates, and etching process are provided. One such method includes applying a clamping voltage to an electrostatic chuck sufficient to hold a wafer in a substantially planerized orientation adjacent to the electrostatic chuck. A heat transfer fluid flows through a three dimensional space between the wafer and the electrostatic chuck to cool the wafer by convective heat transfer during wafer processing.

### FIELD

The disclosure relates to wafer processing methods and apparatus, and in a particular exemplary embodiment to improved methods for processing and cooling wafers during wafer processing steps for making micro-fluid ejection head structures.

### BACKGROUND AND SUMMARY

Micro-fluid ejection heads are useful for ejecting a variety of fluids including inks, cooling fluids, pharmaceuticals, lubricants and the like. One use of micro-fluid ejection heads is in an ink jet printer. Ink jet printers continue to be improved as the technology for making the micro-fluid ejection heads continues to advance. New techniques are constantly being developed to provide low cost, highly reliable printers which approach the speed and quality of laser printers. An added benefit of ink jet printers is that color images can be produced at a fraction of the cost of laser printers with as good or better quality than laser printers. All of the foregoing benefits exhibited by ink jet printers have also increased the competitiveness of suppliers to provide comparable printers in a more cost efficient manner than their competitors.

One area of improvement in the printers is in the micro-fluid ejection head itself. This seemingly simple device is a relatively complicated structure containing electrical circuits, ink passageways and a variety of tiny parts assembled with precision to provide a powerful, yet versatile micro-fluid ejection head. The components of the ejection head must cooperate with each other and with a variety of ink formulations to provide the desired print properties. Accordingly, it is important to match the ejection head components to the ink and the duty cycle demanded by the printer. Slight variations in production quality can have a tremendous influence on the product yield and resulting printer performance.

In order to improve the quality of the micro-fluid ejection heads, new techniques for fabricating components of the heads are being developed. For example, electrostatic chucks may be used to hold a wafer during Deep Reactive Ion Etching (DRIE) and other wafer processing steps. DRIE is used in various ways including to form ink vias in the wafer to provide fluid to ejection actuator devices on a device surface of the wafer. However, DRIE generates heat that can adversely affect components of the micro-fluid ejection head, particularly organic photoresist layers on the ejection head substrate used as masking layers and/or etch stop layers. For example, when a photoresist layer on a surface of the wafer opposite the electrostatic chuck becomes too hot, the photoresist layer becomes prone to crosslinking. Crosslinking creates substantial difficulties in removing the photoresist layer, leaving the surface less planar and more difficult to attach other important micro-fluid ejection head layers to the wafer.

Accordingly, the electrostatic chuck typically includes a heat transfer fluid that flows through an electrode layer of the chuck to cool the chuck which may then cool the wafer by convective cooling. A problem with conductive cooling is the inefficiency of cooling the wafer and other associated micro-fluid ejection head layers using cooling methods and structures that are based on the theory of conductive heat transfer alone. Conductive heat transfer is inefficient because, among other factors, void spaces between the electrostatic chuck(s) and the wafer act as heat transfer insulators.

Another problem associated with the cooling of wafers during DRIE procedures is the presence of a polymer etch stop layer between the wafer and the electrostatic chuck. The presence of a polymer etch stop layer creates an additional layer of heat transfer insulation that theoretically works against the removal of heat energy from the wafer. In addition, the polymer etch stop layer creates additional steps in micro-fluid ejection head fabrication processes. If the steps associated with adding and removing the etch stop layer could be avoided, time and money may be saved by shortening the overall fabrication process.

In view of the foregoing, exemplary embodiments disclosed herein provide a method and apparatus for processing wafers such as those used for making micro-fluid ejection heads. One such method includes applying a clamping voltage to an electrostatic chuck sufficient to hold a wafer in a substantially planarized orientation adjacent to the electrostatic chuck. A heat transfer fluid flows through a three dimensional space between the wafer and the chuck to cool the wafer by convective heat transfer during wafer processing.

Another embodiment disclosed herein provides a wafer processing apparatus. The apparatus includes an electrostatic chuck for clamping a wafer thereto, wherein a three dimensional space is defined between the chuck and the wafer when clamped thereto. A heat transfer fluid source is provided for flowing a heat transfer fluid substantially through the three dimensional space during processing of the wafer. The heat transfer fluid is effective to remove heat by convective heat transfer from the wafer during the processing.

An advantage of the exemplary methods and apparatus described herein is the ability to cool the wafer with a more efficient convective cooling process thereby reducing the occurrences of polymer cross-linking that may occur during DRIE processes used to etch the wafer. As described herein, the primary mode of heat exchange during wafer processing is convection, not conduction. Hence, efficiency and reliability of heat transfer during the etching of wafers may be significantly improved by using cooling methods and structures that specifically cater to convective heat transfer rather than conductive heat transfer.

### BRIEF DESCRIPTION OF THE DRAWINGS

Further features and advantages of the disclosed embodiments may become apparent by reference to the detailed description when considered in conjunction with the figures, which are not to scale, wherein like reference numbers indicate like elements through the several views, and wherein:

FIG. 1 is a cross-sectional view, not to scale, of a wafer processing apparatus;

FIGS. 2A and 2B are cross-sectional views, not to scale, of a wafer processing apparatus according to an exemplary embodiment disclosed herein;

FIGS. 3 and 4 are cross-sectional views, not to scale, of an apparatus processing wafers with and without an etch stop layer;

FIG. 5 is a plan view, not to scale, of an embodiment of a dielectric layer for a wafer processing apparatus as disclosed herein; and

FIG. 6 is a cross-sectional view, not to scale, of an embodiment of a wafer containing a plurality of etched features therein according to an exemplary embodiment disclosed herein.

### DETAILED DESCRIPTION OF THE EXEMPLARY EMBODIMENTS

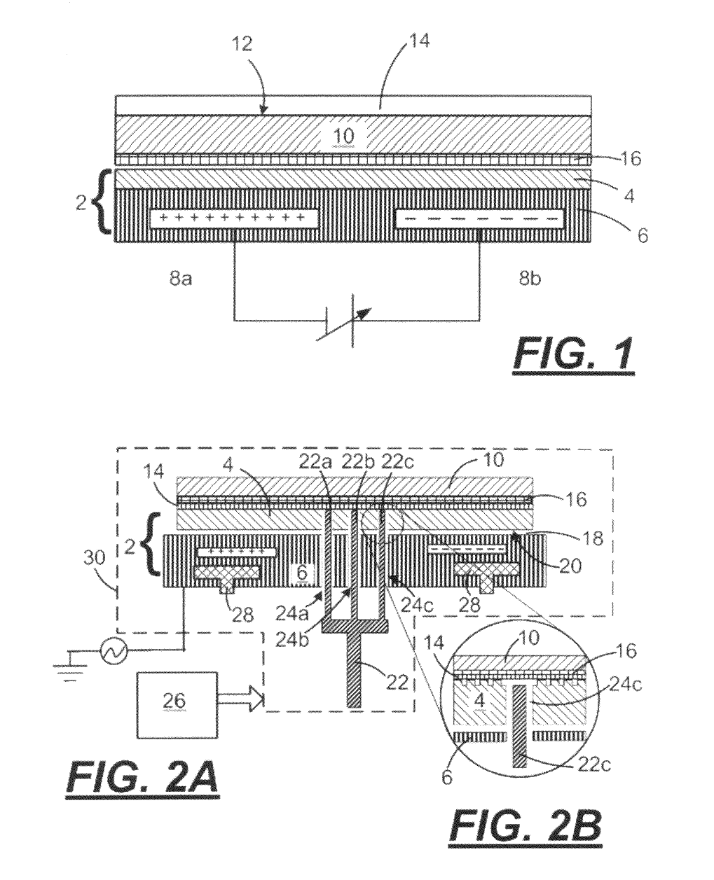

With reference to FIG. 1, an electrostatic chuck 2 is shown, including a dielectric layer 4, an electrode layer 6, and positive and negative electrodes 8a and 8b disposed in the electrode layer 6. The electrostatic chuck 2 shown in FIG. 1 is used to hold a wafer 10 for a wafer processing step. The wafer 10 typically contains a plurality of substrates selected from semiconductor substrates, ceramic substrates, glass substrates, or any other material suitable for use in or with, for example, a micro-fluid ejection head device. For example, each of the substrates on the wafer 10 may have a plurality of fluid ejection actuators such as piezoelectric devices or heater resistors formed on the wafer surface 12. During one wafer processing step, the wafer 10 is etched to provide a fluid flow slot(s) in the substrate(s) for fluid flow to the fluid ejection actuators from a fluid source which is typically opposite the surface 12 of the wafer. In an exemplary embodiment, such etching may be conducted using Deep Reactive Ion Etching (DRIE).

The DRIE process (and other similar processes) generates heat, which may result in undesirable effects with respect to polymeric substances deposited on the wafer surface 12. For example, layers, such as organic photoresist layer 14, are typically used to provide an etch mask for the DRIE process. The photoresist layer 14 is deposited on the wafer surface 12 before DRIE is performed and is removed subsequent to the DRIE step. The wafer 10 also includes an etch stop layer 16 positioned between the dielectric layer 4 and the wafer 10 to prevent the DRIE process from etching onto the dielectric layer 4 of the electrostatic chuck 2. Since the DRIE process generates heat, the wafer 10 may have a temperature increase that causes the organic photoresist layer 14 to crosslink, thereby making the photoresist layer 14 very difficult to remove after the DRIE step is completed. The presence of undesirable residual photoresist layer material on the wafer may result in an uneven wafer surface 12, thereby affecting the subsequent adhesion of other layers, such as those used for making micro-fluid ejection heads, to the wafer surface 12.

Various exemplary embodiments described herein may offer ways to avoid undesirable heating and/or the resultant uneven surface effects caused by lingering photoresist residue. FIG. 2 shows an embodiment of the electrostatic chuck 2, including a dielectric layer 4 and an electrode layer 6, with a wafer 10 electrostatically clamped thereto. A fluid flow space 18 is located between a lower surface 20 of the dielectric layer 4 and the electrode layer 6. A lifting pin assembly 22 may be used to regulate a clearance space between the dielectric layer 4 and the wafer 10.

In the embodiment shown in FIG. 2, the lifting pin assembly 22 includes three lifting pins 22a, 22b, and 22c that are partially housed and movable within three lifting pin orifices 24a, 24b, and 24c defined within the dielectric layer 4 and the electrode layer 6. For the purposes of this disclosure, the total number of lifting pins 22a-22c is irrelevant. A heat transfer fluid source 26 provides heat transfer fluid through the central orifices 24a-24c to cool the wafer 10. A wafer cooling zone 30 containing the electrostatic chuck 2 is illustrated in FIG. 2 by a dotted line.

In prior electrostatic chuck designs, the bulk of the heat transfer was by conduction from the wafer 10 through the dielectric layer 4 and the electrode layer 6 to the fluid circulating in heat exchangers 28. However, more effective heat transfer may be provided by convective heat transfer from the wafer 10, as described more fully herein, rather than by conductive heat transfer alone through the dielectric layer 4 and electrode layer 6.

Without being bound by theory, some basic equations are given below for the principles described herein. An electrostatic clamping force (F) applied to an object such as wafer 10 may be derived from Equation 1 as follows:

F=A×P=[εₒ/2×[(Vεᵣ)/(d+εᵣg)] (Eq. 1)

F=electrostatic clamping force

A=surface area

P=electrostatic pressure

εₒ=vacuum dielectric constant

V=voltage across the dielectric

εᵣ=relative constant of the dielectric

g=gap distance between the substrate and the dielectric

d=dielectric thickness

Thermal conduction (q_{cond}) is described by Equation 2 below, wherein “dX” represents, in its integrated form, distance between the boundaries of a particular heat transfer zone.

q_{cond}=−kAdT/dX (Eq. 2)

Equation 2 suggests that an increase in distance for heat transfer to take place correlates to a decrease in thermal conductivity via conduction. However, contrary to conventional wisdom, when an etch stop layer (like etch stop layer 16 in FIG. 2) is removed, the conductive heat transfer from the wafer 10 surprisingly decreases.

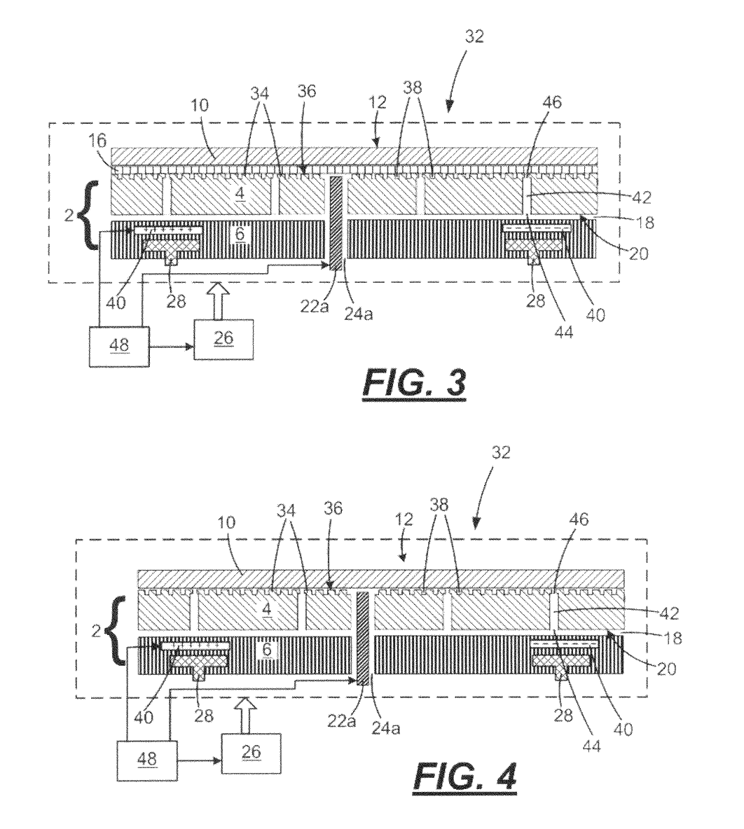

FIG. 3 illustrates an electrostatic chuck 2 coupled to a wafer 10 with a 30 μm thick etch stop layer 16—a thermal insulator—located between the chuck 2 and the wafer 10. FIG. 4 illustrates the same electrostatic chuck 2 and wafer 10 with no etch stop layer between the chuck 2 and the wafer 10. Based on well known heat transfer theory, the structure shown in FIG. 4 should allow for greater heat transfer via conduction from the wafer 10 to the electrostatic chuck 2 because a shorter distance exists between the wafer 10 and the chuck 2. However, according to recent experimental results, when the etch stop layer 16 is present, the temperature of the wafer is about 70° C. as compared to about 95° C. when the etch stop layer 16 is absent from the wafer.

A number or pertinent equations illustrating convective heat transfer and the factors that play a role in convective heat transfer are shown below as follows:

q_{conv}=h_{c}AΔT (Eq. 3)

h_{c}=convection coefficient=(k/L)Nu_{L} (Eq. 4)

Nu_{L}=0.664(Pr)^{1/3}(Re_{L})^{1/2} (Eq. 5)

Pr=v/α=Cₚμ/k (Eq. 6)

v=kinematic viscosity measured in m²/s

Cₚ=specific heat measured in J/Kg-° K

μ=dynamic viscosity measured in Kg/m-s

α=thermal diffusivity measured in m²/s

Re_{L}=μ_{∞}L/v=ρμ_{∞}L/μ (Eq. 7)

ρ=density measured in Kg/m³

μ_{∞}=free stream velocity measured in (m/s)

h_{c}=(k⁴Cₚ²μ²μ_{∞}³/L³v³)^{1/6} (Eq. 8)

h_{c}=(k⁶v²ρ³μ_{∞}³/L³α²μ³)^{1/6} (Eq. 9)

While not desiring to be bound by theory, an explanation for the difference in heat transfer described above appears to be threefold as follows:
(1) The presence of the etch stop layer 16—a nonuniform film—creates increased voids of space for a fluid (such as helium) to flow. Equation 3 above demonstrates that increasing the area of fluid contact increases convective heat transfer.
(2) The presence of a non-uniform edge bead along the etch stop layer 16 increases the potential for the fluid to escape from between the wafer 10 and dielectric layer 4, thereby removing heat via convection. Increased fluid flow correlates into increased convective beat transfer as shown by Equations 4, 5, and 7 above.
(3) The presence of the etch stop layer 16 further decreases the clamping force of the electrostatic chuck 2 thereby increasing the gap distance (g) as shown in Equation 1, hence allowing for more fluid to escape from between the wafer 10 and dielectric layer 4, thereby removing heat via convective heat transfer.

There is additional evidence to suggest that convective heat transfer is a more efficient mode of cooling the wafer. Convection is at work in the example described above. During certain experiments, when a helium source (similar to heat transfer fluid source 26 in FIG. 2) was turned off, thereby cutting off helium supply to the wafer cooling zone 30, the temperature of the wafer 10 increased from about 70° degrees Centigrade to above 170° degrees Centigrade. Based on heat transfer theory, the removal of helium should have had a minimal effect on conductive heat transfer because the thermal conductivity of helium gas is substantially lower than the thermal conductivity of Aluminum Oxide-the primary material making up the electrostatic chuck 2. However, contrary to the theory set forth above, the primary mode of heat transfer according to the experimental results described above is convective heat transfer.

In addition to the evidence discussed so far that convection is the primary mode of heat transfer in the experimental results discussed above, experiments were conducted in which helium pressure within the wafer cooling zone 30 was doubled. After the pressure was raised from about 10 torr to about 20 torr the temperature of the wafer 10 decreased from about 95° degrees Centigrade to about 70° C. degrees Centigrade. Based on the equations listed above, a change in pressure should have no effect on conductive heat transfer. However, a change in pressure will directly affect convection convective heat transfer as shown in Equation 7 with reference to fluid density “ρ”. Therefore, the primary mode of heat transfer in the example given above again appears to be convection, not conduction. Hence, a change in helium pressure supports the belief that convective heat transfer is a more effective means of cooling the wafer 10.

Based on the experimental results described above, the present inventors identified a need to maximize convective heat transfer within the wafer cooling zone 30.

With reference to the equations listed above, the factors that may be increased in order to increase convective heat transfer in the wafer cooling zone 30 include the surface area (A) of heat transfer fluid in contact with wafer 10, a difference in temperature (ΔT) between boundary points in the wafer cooling zone 30, a thermal conductivity (k) of the heat transfer fluid, the specific heat (Cₚ) of the heat transfer fluid, the free stream velocity (μ_{∞},) and the fluid density (ρ). One factor that may be minimized includes a length (L) across which convective heat transfer is occurring.

In order to increase the area (A) for heat transfer between the wafer 10 and the electrostatic chuck 2 using the heat transfer fluid, physical changes to the electrostatic chuck 2 may be made. Similar physical changes to an electrostatic chuck may be made to affect the free stream velocity (μ∞) the fluid density (ρ), the length (L) of the dielectric layer 4, and the (ΔT) between boundary points in the wafer cooling zone 30. These physical changes are discussed below with regard to various exemplary embodiments of a wafer processing apparatus. Changes to the heat transfer fluid itself such as thermal conductivity (k) and specific heat (Cp) may all be altered by changing various process parameters as described in more detail below.

With reference again to FIGS. 3-4, a wafer processing apparatus 32 is shown. The only difference between FIG. 3 and FIG. 4 is the presence of etch stop layer 16 in FIG. 3. Both FIG. 3 and FIG. 4 illustrate embodiments of the apparatus 32 described herein including the electrostatic chuck 2, which further includes the dielectric layer 4 and the electrode layer 6. The dielectric layer 4 is suitably made of or includes a major amount of aluminum oxide (Al₂O₃), aluminum nitride (AlN), beryllium oxide (BeO), diamond (C), and/or other compound or elemental material with similar physical properties known to those skilled in the art.

The electrostatic chuck 2 shown in FIGS. 3-4 includes a plurality of mesas 34 on an upper surface 36 of the dielectric layer 4 wherein the plurality of mesas 34 define a three dimensional space 38 between the plurality of mesas 34 and the etch stop layer 16 or wafer 10 that allows for a heat transfer fluid to directly contact the etch stop layer 16 or the wafer 10. By minimizing the size of the mesas 34, the contact area A between the dielectric layer 4 and the etch stop layer 16 or wafer 10 is decreased and the three dimensional space 38 is increased, thereby increasing convective heat transfer as shown in Equation 3 above. In an exemplary embodiment, the average cross-sectional contact area (A) on a surface of each individual mesa is between about 0.1 mm² and about 2 mm², such as between about 0.5 mm² and about 2 mm².

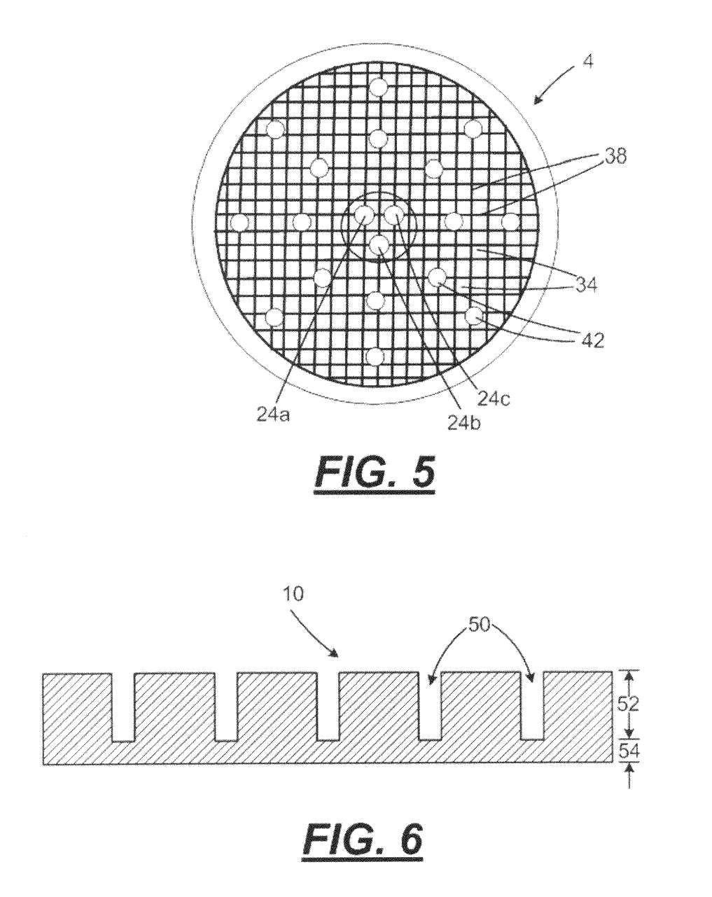

FIG. 5 is a plan view of the dielectric layer 4 illustrating the cross-sectional contact areas (A) of mesas 34. As shown in FIG. 5 the three dimensional spaces 38 crisscross the dielectric layer 4 to provide substantially rectangular mesas 34. The clamping force (F) is a function of mesa height (gap distance g) as shown by equation 1 above. In order to maintain the same clamping force (F) as with larger mesa surface areas, the mesa height may be reduced.

The electrostatic chuck 2 in the embodiment shown in FIGS. 3-4 also includes a plurality of electrodes 40 to apply a clamping force to hold the wafer 10 adjacent to the electrostatic chuck 2. As described above, the heat transfer fluid source 26 provides the heat transfer fluid and for the flow of the heat transfer fluid through the wafer cooling zone 30. The cooling zone 30 includes the three dimensional space 38 and the fluid flow space 18, located between a lower surface 20 of the dielectric layer and the electrode layer 6.

In a related embodiment, the apparatus 32 may also include a feedback control system 48. The feedback control system 48 may monitor the electrostatic clamping force as defined in Equation 1 and/or the pressure of the heat transfer fluid within the wafer cooling zone 30 Those skilled in the art appreciate that the pressure as measured within the cooling zone 30 is directly proportional to the heat transfer fluid density (ρ), defined in Equation 7. In this embodiment, the feedback control system 48 may have the capability to manipulate both the clamping force and the heat transfer fluid pressure by controlling electrical flow to the plurality of electrodes 40 and heat transfer fluid flow rate to the wafer cooling zone 30, respectively. By controlling the clamping force and/or the heat transfer fluid flow rate into the cooling zone 30, the feedback control system 48 may effectively control the flow rate of the heat transfer fluid through the cooling zone 30, thereby directly affecting the free stream velocity (μ₂₈ ) and the fluid density (ρ). By increasing both or either of the free stream velocity (μ_{∞}) and the fluid density (ρ), convective heat transfer is increased as shown by Equations 3, 8, and 9 above.

In an exemplary embodiment, electrostatic chucks like electrostatic chuck 2 include a conductive cooling system including heat exchangers 28 for circulating a cooling fluid through the electrode layer 6 for conductive cooling of the dielectric layer 4 and wafer 10. Heat exchangers 28 are located, in part, within the electrode layer 6 to provide the conductive cooling. In an exemplary embodiment, the heat exchangers 28 include a liquid coolant circuit wherein the liquid cooling agent used therein has properties similar to or identical to a silicon-based heat transfer fluid available from Dow Chemical Company of Midland, Mich., under the trade name SYLTHERM.

In another exemplary embodiment, the dielectric layer 4 includes a plurality of convection orifices 42 as shown in FIGS. 3-5. The convection orifices 42 (along with the one or more lifting pin orifices 24) define a plurality of first ports 44 located on the surface 20 of the dielectric layer 4 and a plurality of second ports 46 located on the surface 36 of the dielectric layer 4. Though the dielectric layer 4 shown in FIG. 5 shows a total of sixteen convection orifices 42 (not counting the central orifices 24 through which the lifting pin assembly 22 extends), various exemplary embodiments may include as few as one convection orifice 42 and as many as about one hundred convection orifices 42 through the dielectric layer 4. By increasing the number of convection orifices 42 in dielectric layer 4, the length L as defined in Equations 4, 8, and 9 above is shortened and heat transfer by convective cooling is increased.

In addition to the various embodiments of the apparatus 32 described above, another exemplary embodiment includes a method for making a micro-fluid ejection head structure. For illustrative purposes, the electrostatic chuck 2 and wafer 10 as shown in FIGS. 3-6 are used here to describe this and other embodiments of methods of the exemplary embodiments. According to the embodiment, a first step of the method includes applying a clamping voltage to electrostatic chuck 2 to hold a wafer 10 in a substantially planar orientation against the electrostatic chuck 2. In a second step, a heat transfer fluid flows through a three-dimensional space defined at least in part between the electrostatic chuck 2 and the wafer 10. By flowing through the three dimensional space—a space which may also includes fluid flow space 18—heat is removed from the electrostatic chuck 2 and the wafer 10.

In the method described above, the heat transfer fluid used might be a forming gas, wherein the forming gas includes, but is not limited to, a gas mixture of helium and hydrogen. A forming gas, as understood herein, includes from about 90 percent to about 99 percent helium and from about 1 percent to about 10 percent hydrogen by volume. The forming gas might be desirable because of its nonvolatile properties, its very high specific heat (Cₚ) value, and its relatively high thermal conductivity (k). The presence of only about 5 percent hydrogen by volume in the forming gas is capable of increasing convective heat transfer by almost 30 percent as compared to using substantially pure helium. This is true because hydrogen has a very high specific heat (Cₚ) value.

In other related embodiments, the heat transfer fluid used in the method described above may be substantially pure helium, substantially pure hydrogen, or other fluids with similar thermal properties. If substantially pure hydrogen is used, heat transfer by convection is theoretically improved by almost 600 percent as compared to the use of pure helium. However, the use of the forming gas allows for the benefit of some hydrogen being present without the negative effects such as high reactivity when using higher concentrations of hydrogen.

In another exemplary embodiment of the method described above, the heat transfer fluid is allowed to leak from the wafer cooling zone 30 at a desired rate In an exemplary embodiment, the leak rate is controlled using the feedback control system 48 shown in FIG. 2. The feedback control system 48 may have the capability to manipulate both the clamping force and/or the heat transfer fluid pressure by controlling electrical flow to the plurality of electrodes 40 and the forming gas flow rate to the wafer cooling zone 30, respectively By controlling the clamping force and/or the forming gas flow rate into the cooling zone 30, the feedback control system 48 effectively controls heat transfer by affecting the free stream velocity (μ_{∞}) and the fluid density (ρ) of the forming gas. By increasing both or either of the free stream velocity (μ_{∞}) and the fluid density (ρ) convective heat transfer is increased as shown by Equations 3, 8, and 9 above.

In a related embodiment, heat transfer fluid may also be allowed to leak through a reclamation port, such as a valve or other similar device known to those skilled in the art. The presence of the reclamation port allows for the pressure of the heat transfer fluid to be increased without forcing the wafer 10 off of the electrostatic chuck 2. By increasing the pressure, the flow rate of the heat transfer fluid is increased, thereby increasing convective heat transfer as shown by equations 3 and 8 above. Moreover, heat transfer fluid leakage along the edge of the wafer becomes less necessary because heat transfer fluid is allowed to escape through the reclamation port, thereby allowing the necessary convective heat transfer. Increasing the clamping force allows for the heat transfer fluid pressure to be increased without forcing the wafer 10 off of the electrostatic chuck 2. As stated above with reference to equations 3 and 8, increased heat transfer fluid pressure translates into increased convective heat transfer.

In yet another embodiment, a method is provided similar to the methods described above, but further including a step for cooling the heat transfer fluid, such as using heat exchangers 28 shown in FIGS. 3-4. The heat exchangers 28 are may be located at least partially within the electrode layer 6 shown in FIGS. 3-4 and might include coolant circuits. As the heat transfer fluid flows through the wafer cooling zone 30 and through the portion of the cooling zone 30 closest to the heat exchanger 28 (i.e., the fluid flow chamber 18), the heat transfer fluid is cooled as it exchanges heat with the electrode layer 6 and/or dielectric layer 4. The heat transfer fluid may flows turbulently throughout and ultimately out of the wafer cooling zone 30, continually exchanging heat with the dielectric layer 4 and the wafer 10 during a process such as DRIE.

In a related embodiment in which the wafer 10 includes, for example, a plurality of micro-fluid ejection head substrates, the method includes a step of dicing the wafer 10 to separate at least some of the substrates from the wafer. After dicing the wafer 10, the individual substrates may be used to form more complex structures, such as fluid ejection heads in fluid ejection devices such as, for example, ink jet printers.

In another exemplary embodiment, the methods described above include clamping a wafer to an electrostatic chuck and flowing heat transfer fluid through the three dimensional space within the wafer cooling zone 30. Additionally the method might includes a step of etching partially through the wafer 10 such as by using DRIE. By not etching completely through the wafer 10, the need for an etch stop layer such as etch stop layer 16 could be circumvented.

FIG. 6 provides an illustration of a wafer etched according to the foregoing etching step. Features 50 etched in the wafer 10 (e.g., by a DRIE process) extend part way through the wafer 10 as shown by etch distance 52. The remaining distance 54 is minimal such that the features 50 may be subsequently ground off using grinding techniques known to those skilled in the art. The foregoing procedure circumvents the need for using the etch stop layer 16 (shown in FIG. 3) on the wafer 10 to protect the electrostatic chuck 2. In this embodiment, a wafer 10 having an overall thickness ranging from about 50 microns to about 800 microns may be etched using the DRIE step, as described above, while the remaining distance 54 protects the dielectric layer 4 from etching. After the DRIE step, the remaining distance 54 may be ground off of the wafer 10 providing fully developed features 50 completely through the wafer.

According to the foregoing procedure, the etch distance 52 may range from about sixty percent to about ninety-five percent of the overall average thickness of the wafer 10. During the etching step, the wafer 10 is cooled using one or more of the other method steps and apparatus described above. The wafer 10 is subsequently removed from the electrostatic chuck 2 and the remaining distance 54 is ground off to open features 50 through the wafer 10. By using the steps outlined in this embodiment a number of steps are eliminated including, but not limited to, an initial grinding step before the etching step, the step of adding the etch stop layer 16 to the wafer 10, and the step of removing the etch stop layer 16 from the etched wafer 10.

Having described various aspects and embodiments of the disclosure and several advantages thereof, it will be recognized by those of ordinary skills that the embodiments described herein are susceptible to various modifications, substitutions and revisions within the spirit and scope of the appended claims.

What is claimed is:

1. A method for processing a wafer, the method comprising:
applying a clamping voltage to an electrostatic chuck sufficient to hold a wafer in a substantially planarized orientation adjacent to the electrostatic chuck; and
flowing a heat transfer fluid through a three dimensional space between the wafer and the electrostatic chuck to cool the wafer by convective heat transfer during wafer processing

2. The method of claim 1, wherein the heat transfer fluid comprises a gas selected from the group consisting of hydrogen, helium, and a mixture thereof.

3. The method of claim 1, further comprising controlling a leak rate of the heat transfer fluid from the three dimensional space.

4. The method of claim 1, further comprising cooling the heat transfer fluid using a heat exchanger.

5. The method of claim 1, wherein the wafer processing comprises etching the wafer to provide a fluid supply slot therein wherein the fluid supply slot is etched to a distance through the wafer ranging from about sixty percent to about ninety-five percent of a first wafer thickness, thereby defining an etch distance and a remaining distance.

6. The method of claim 5 further comprising grinding the wafer to remove the remaining distance to provide a second wafer thickness so that the fluid supply slot extends through the second wafer thickness and the second wafer thickness is less than the first wafer thickness.

7. The method of claim 1, wherein the wafer comprises a plurality of micro-fluid ejection head substrates, further comprising dicing the wafer to separate the substrates from the wafer.

8. The method of claim 1, wherein the wafer processing comprises deep-reactive ion etching.

9. A wafer processing apparatus comprising:
an electrostatic chuck for clamping a wafer thereto, wherein a three dimensional space is defined between a surface of the electrostatic chuck and the wafer when clamped thereto; and
a heat transfer fluid source for flowing a heat transfer fluid substantially through the three dimensional space during processing of the water, wherein the heat transfer fluid is effective to remove heat by convective heat transfer from the wafer during the wafer processing.

10. The apparatus of claim 9 wherein the electrostatic chuck further comprises an electrode layer and a dielectric layer.

11. The apparatus of claim 10, wherein the dielectric layer further comprises a plurality of orifices through which heat transfer fluid flows wherein the plurality of orifices define at least two first ports located on a first surface of the dielectric layer and at least two second ports located on a second surface of the dielectric layer.

12. The apparatus of claim 9, further comprising an electrode layer coolant circuit, wherein the coolant circuit is capable of removing heat from the heat transfer fluid as at least some of the heat transfer fluid flows through a fluid flow space between the dielectric layer and the electrode layer.

13. The apparatus of claim 9, further comprising a feedback control system for controlling a rate of heat transfer fluid leakage from the three dimensional space.

14. The apparatus of claim 13, wherein the feedback control system is capable of monitoring and manipulating a clamping force between the electrostatic chuck and the wafer.

15. The apparatus of claim 13, wherein the feedback control system is capable of controlling the velocity of the heat transfer fluid through the three dimensional space.

16. The apparatus of claim 9, wherein the surface of the chuck includes a plurality of mesas capable of defining the three-dimensional space when a wafer is clamped thereto, and wherein the average cross-sectional area of the plurality of mesas comprises an area ranging from about 0.1 mm² to about 2.0 mm².

17. The apparatus of claim 9 wherein the dielectric layer of the electrostatic chuck is selected from the group consisting of aluminum oxide (Al₂O₃), aluminum nitride (AlN), beryllium oxide (BeO), and diamond (C).

18. A micro-fluid ejection head substrate made by the method of claim 7.

19. A micro-fluid ejection head substrate made using the apparatus of claim 9.

20. An etching process using the apparatus of claim 9.
